(19) United States
(12) Patent Application Publication
(10) Pub. No.: US 2007/0075108 A1
(43) Pub. Date: Apr. 5, 2007

(54) Low profile flush mount roof rack with rotating cross rail system

(75) Inventor: Craig Alan Stapleton, St. Clair, MI (US)

Correspondence Address: WARN, HOFFMANN, MILLER & LALONE, .P.C, PO BOX 70098, ROCHESTER HILLS, MI, 48307, US

(73) Assignee: Magna International Inc., Aurora (CA)

(21) Appl. No.: 11/243,673

(22) Filed: Oct. 5, 2005

(51) Int. Cl. B60R 9/00

(52) U.S. Cl. 224/321; 224/325

(57) ABSTRACT

The present invention relates to a roof rack that provides side rails which extend along the vehicle's roof panel. The roof rack has cross rails that extend between the side rails, but the cross rails can change positions so that when they are not in use they are at a lower height then when they are in use. The cross rails are connected to a stanchion which is then connected to the side rails by a connector. The stanchion pivots about this connection point in order to alter the height of the cross rails. The side rails have a stanchion stopper which is positioned adjacent to the stanchion in order to prevent over rotation of the stanchion.

### FIELD OF THE INVENTION

The present invention relates to a low profile roof rack that has a rotating cross rail.

### BACKGROUND OF THE INVENTION

Many vehicles, especially sport utility vehicles and mini vans, have roof racks so that items can be stored on the roof of the vehicle. Vehicles can have standard roof racks which are installed on all the vehicles of a particular model during production or add-on roof racks which are custom to the vehicle and are usually installed after the vehicle has been manufactured. Whether a vehicle has a standard roof rack or an add-on roof rack, the roof racks normally extend several inches above a vehicle's roof panel. A roof rack that extends several inches above the roof panel is undesirable because the roof rack results in additional wind resistance which can affect the fuel efficiency of the vehicle. Also, the air flow over the roof rack, especially the cross rails, can cause additional noise due to the wind stream over the vehicle, which can be heard in the passenger compartment of the vehicle. Another undesirable effect of having a roof rack extending several inches above the vehicle's roof panel is the poor aesthetic effect that the roof rack has on the vehicle's design.

Therefore, it would be ideal to have a roof rack that would have cross rails that could be positioned closer to the vehicle's roof panel when the roof rack is not in use, but where the distance separating the cross rails and the roof panel could be increased when the roof rack is in use. If the height of the cross rails could be reduced when the roof rack is not in use the wind resistance caused by the roof rack would be reduced which would increase the fuel efficiency of the vehicle. Also, the noise caused by the air flow around the roof rack would be reduced. Moreover, the aesthetics of the overall vehicle design would be improved because the roof rack would not be as noticeable. Furthermore, it would be ideal that when the roof rack is in use the cross rails could be positioned with enough separation between the cross rails and the roof panel to accommodate items where a portion of the stored item hangs below the cross rails, such as ski brakes on downhill skies.

### SUMMARY OF THE INVENTION

The present invention relates to a roof rack that has side rails that extend along vehicle's roof panel. The roof rack has cross rails that extend between the side rails, but the cross rails can change positions so that when they are not in use they are at a lower height then when they are in use. The cross rails are connected to a stanchion which is then connected to the side rails by a connector. The stanchion pivots about this connection point in order to alter the height of the cross rails. The side rails have a stanchion stopper which is positioned adjacent to the stanchion in order to prevent over rotation of the stanchion. For example, if the vehicle is required to make a sudden stop the momentum of the items being stored on the roof rack may apply a force to the stanchion that would result in over rotation of the stanchion. Over rotation of the stanchion could cause damage to the vehicle's roof panel and possibly to other parts of the vehicle and the items being stored on the roof rack. Therefore, the stanchion stopper prevents stanchion from rotating in an undesirable direction at undesirable times.

The side rails have angled exterior surfaces so that the side rails blend with the vehicle's roof line in order for the roof rack to be less conspicuous. In addition, the roof rack has front and rear air dams which have angled surfaces that face opposite each other. Thus, the front air dam's angled surface faces the front of the vehicle and the rear air dam's angled surface faces the rear of the vehicle. However, both the front and rear air dams decrease the amount of wind resistance caused by the roof rack which increases the fuel efficiency of the vehicle and reduces the noise caused by the vehicle's wind stream over the roof panel. In addition, the angled surfaces of the front and rear air dams have an aesthetic function. Since the bases of the angled surfaces start at the roof panel and the tops of the angled surfaces extend to the tops of the side rails the angled surfaces disguise the roof rack. Thus, the aesthetic design of the vehicle is improved as well.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a prospective view of the roof rack in the resting position;

FIG. 2 is a prospective view of the roof rack in the deployed position;

FIG. 3 is an exploded prospective view of the roof rack;

FIG. 4 is a cross-sectional view along the line A-A of FIG. 3; and,

FIG. 5 is a cross-sectional view along the line B-B of FIG. 3.

### DETAILED DESCRIPTION OF THE PREFERRED EMBODIMENTS

The following description of the preferred embodiment(s) is merely exemplary in nature and is in no way intended to limit the invention, its application, or uses.

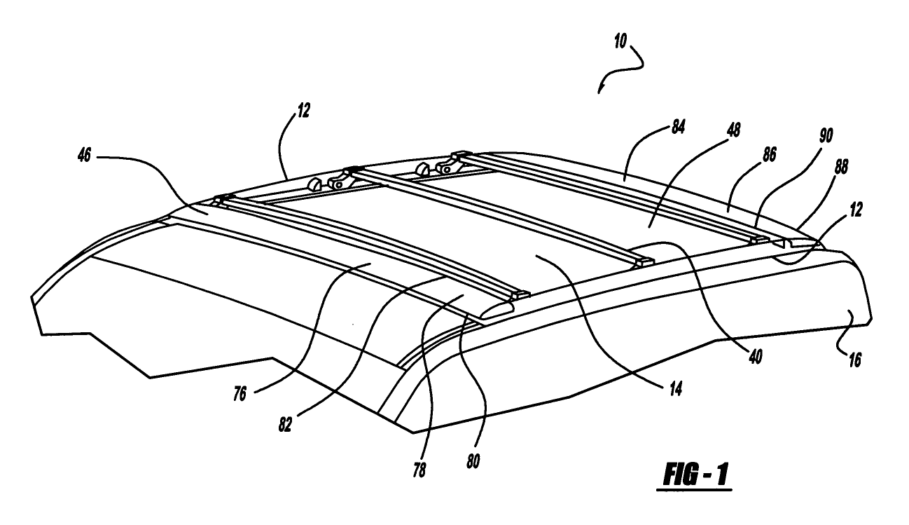

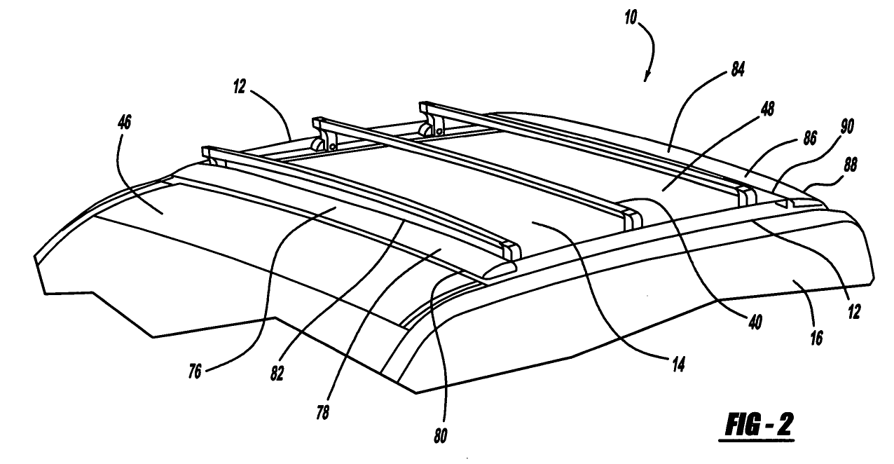

Referring to FIGS. 1 and 2 a roof rack 10 is shown. FIG. 1 depicts the roof rack 10 in its first position, or resting position, and FIG. 2 depicts the roof rack 10 in its second position, or deployed position. The roof rack 10 has side rails 12 which extend along the vehicle's roof panel 14. It is preferred that the roof rack 10 has two side rails 12 that extend parallel to the vehicle's sides 16. A gasket 18 can be placed between the roof panel 14 and the side rails 12. A gasket 18 is used in order to provide a mounting surface for the side rails 12 so that the base 20 of the side rails 12 will not damage the roof panel's 14 paint or cause structural damage to the roof panel 14. However, using a gasket 18 is optional. One factor of consideration when determining if a gasket 18 should be used is the material used to mold the side rails 12. For example, if the side rail 12 is unfilled then a gasket 18 is unnecessary. One example for attaching the gasket 18 to the side rail 12 is by having one end of a snap (not shown) molded into the side rail 12, and having the opposite end of the snap (not shown) molded into the gasket 18. Thus, when the ends of the snaps are aligned the gasket 18 is mechanically attached to the side rail 12. Another example for connecting the gasket 18 to the side rail 12 is where the gasket 18 and the side rail 12 are connected to the roof panel 14 by a screw 22 that extends through the base 20, the gasket 18, and the roof panel 14. On the opposite side of the roof panel 14 as the side rails 12 a lock nut 24 is used to secure the screw 22, thus securing the side rails 12 and the gasket 18 to the roof panel 14.

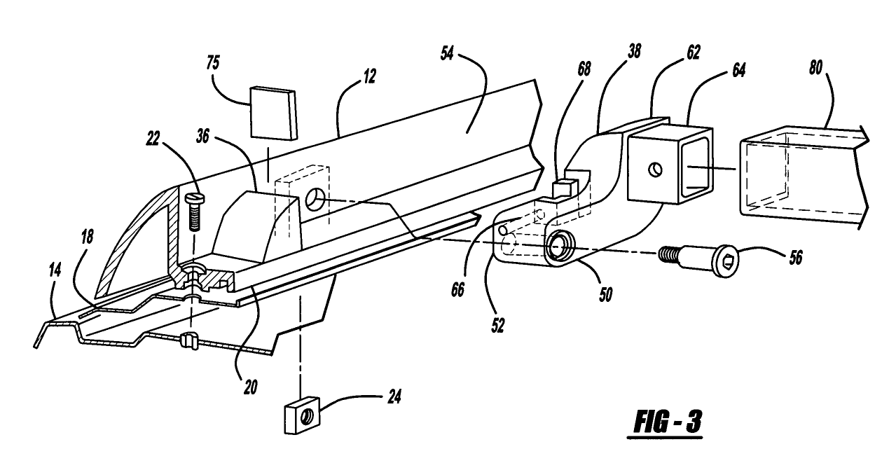

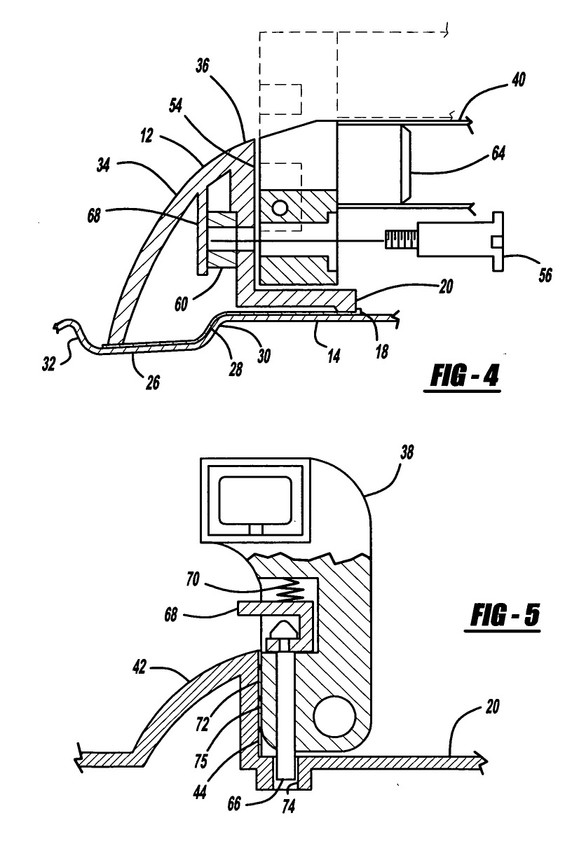

Referring to FIGS. 1, 3, and 4, the roof panel 14 has a gutter 26 that extends in the same direction as the side rail 12. However, the roof gutter 26 is not as wide as the side rail 12 and gasket 18, such that a portion of the side rail 12 and the gasket 18 are placed in the gutter 26. The gasket 18 has an angled surface 28 that remains flush with the roof panel's first slope 30 which forms one end of the roof gutter 26. The gasket 18 can extend across the entire roof gutter 26, but it is preferred that the gasket 18 does not extend onto the roof panel's second slope 32 which forms the second end of the roof gutter 26. In an alternate embodiment, the gasket 18 can extend along the roof panel's second slope 32; thus, the gasket 18 would extend along the entire width of the roof gutter 26. The side rail 12 has an exterior angled surface 34, which forms the exterior side of the side rail 12. The exterior angled surface 34 extends from a top 36 of the side rail 12 to the end of the gasket 18 in the roof gutter 26. Thus, the exterior angled surface 34 extending out of the roof gutter 26 creates an appearance that the side rail 12 is an extension of the roof panel 14. The exterior angled surface 34 also prevents many of the other components of the roof rack 10 from being seen.

Each side rail 12 has at least one stanchion stopper 36 which is used in combination with a stanchion 38 in order to alter the position of the cross rails 40. The stanchion stopper 36 has a shape of a quarter circle, such that the stanchion stopper 36 has an angled front surface 42 and a flat rear surface 44. The angled front surface 42 is on the side of the stanchion stopper 36 that faces a front end 46 of the roof panel 14. The angle of the angled front surface 42 can vary, but the purpose of the angle is to reduce the wind resistance of the roof rack 10. The flat rear surface 44 faces a rear end 48 of the roof panel 14. The flat rear surface 44 is flat so that the stanchion 38 has the maximum surface area possible to contact the stanchion stopper 36. It is preferred that the stanchion stopper 36 be molded into the side rail 12, but the stanchion stopper 36 could be pre-manufactured and attached to the side rail 12 by mechanical means or an adhesive.

Referring to FIGS. 1-5, the stanchion 38 has a resting base 50 and a deployed base 52. When the roof rack 10 is in the resting position, the resting base 50 contacts the base 20, and the deployed base 52 is facing the flat rear surface 44. When the roof rack 10 is in the deployed position, the deployed base 52 contacts the base 20, and the resting base 50 faces towards the rear end 48. The stanchion 38 is attached to a flat side wall 54 of the side rail 12 by a connector 56. The connector 56 extends through the side wall 54 and extends to an attachment wall 58 that is in between the side wall 54 and the exterior angled surface 34. The connector 56 can be further secured by placing a lock nut 60 in between the side wall 54 and the attachment wall 58, so that the connector 56 extends through the lock nut 60. The lock nut 60 can be press fitted in between the side wall 54 and the attachment wall 58 so that the stanchion 38 can be more securely connected and for easier installation. Thus, the stanchion 38 can pivot with respect to the connector 56 in order to move the roof rack 10 from the resting position to the deployed position or vice versa. It is preferred that the connector 56 be a shoulder screw so that the portion of the connector 56 that enters the flat side wall 54 and extends through the lock nut 60 and to the attachment wall 58 is threaded so that a secure connection can be made, and the portion of the connector 56 extending through the stanchion 38 can be a smooth surface. By having a smooth surface extending through the stanchion 38, the stanchion 38 can rotate about the connector 56 more easily.

It is also preferred that the stanchion 38 have an L-shape so that when the roof rack 10 is in the resting position the cross bars 40 are at a lower height than when the roof rack 10 is in the deployed position. By having an L-shape the stanchion 38 will position the cross bars 40 so that they not contacting the roof panel 14 when the roof rack 10 is in the resting position. The cross bar connection end 62 of the stanchion 38 has an extension 64 that is received by the end of the cross bar 40. Thus, it is preferred that the cross bar 40 be hollow in order to receive the extension 64 in addition to the reducing the weight of the roof rack 10. It is also preferred that the extension 64 be hollow so that a locking mechanism can be used to secure the cross bar 40 to the extension 64. For example, a pin (not shown) could extend through two ends of the cross bar 40 and extension 64 and a key (not shown) could be used to secure the pin.

The side of the stanchion 38 that is opposite the resting base 50 has a locking mechanism that consists of a lock pin 66, a lever 68, and a spring 70. When the roof rack 10 is in the resting position the lock pin 66 extends through the stanchion 38 and into a detent recess 72. In order to move the roof rack 10 from the resting position to the deployed position, the stanchion needs to be rotated so that the lock pin 66 will be received by an indexing hole 74 in the base 20. The spring 70 puts sufficient force on the lever 68, which is connected to the lock pin 66, so that when the lock pin 66 is aligned with the indexing hole 74 the lock pin 66 will enter the indexing hole 74. In addition, a bumper pad 75 is attached to the stanchion stopper 36 in order to fill the gap between the stanchion stopper 36 and the stanchion 38 when the roof rack 10 is in the deployed position. Therefore, the bumper pad 75 reduces the noise and vibrations that may be caused between the stanchion stopper 36 and the stanchion 38. It is preferred that the bumper pad 75 is positioned on the stanchion stopper 36 so that it does not occupy the portion of the detent recess 72 that is aligned with the lock pin 66 when the roof rack 10 is in the resting position.

When the roof rack 10 is being moved from the deployed position to the resting position the force of the spring 70 must be removed from the lock pin 66 by using the lever 68. The lever 68 can be raised by applying a sufficient amount of force to overcome the force of the spring 70 so that the lock pin 66 will exit the indexing hole 74. Thus, the stanchion 38 is capable of rotation about the connecter 56. Any type of locking mechanism could be used in order to secure the stanchion 38 when it is in the resting position and the deployed position. Another example of an acceptable locking mechanism would be the use of a slide button mechanism (not shown). In this mechanism a pin is connected to a lever, and the lever is connected to a slide button. Thus, slide button is replacing the spring 70, and when the slide button moves so does the pin. Therefore, when the slide button is down the pin would be engaged and when the slide button is up the pin would be disengaged.

The front end 46 has a front air dam 76 that extends between the side rails 12. It is preferred that the front air dam 76 be molded onto the side rails 12, but the front air dam 76 could be pre-manufactured and attached by mechanical means or adhesive. The front air dam 76 has an angled surface 78 such that a base 80 of the angled surface 78 is at a height that is approximately the same as the base 20. Also, the front air dam 76 has a top 82, which is positioned closer to the rear end 48 than the base 80, that is at a height that is approximately the same as the side rail 12. Therefore, the front air dam 76 reduces the wind resistance of the roof rack 10, and reduces the amount of the roof rack's 10 components that are visible. Similarly, the rear end 48 has a rear air dam 84 that extends between the side rails 12. It is preferred that the rear air dam 84 be molded onto the side rails 12, but the rear air dam 84 could be pre-manufactured and attached by mechanical means or adhesive. The rear air dam 84 also has an angled surface 86 with a base 88 and a top 90. The base 88 and top 90 are also at approximately the same heights as the base 20 and the side rails 12 respectfully. However, the rear air dam 84 differs from the front air dam 76 because the top 90 is closer to the front end 46 than the base 88.

It is also possible for the side rails 12 to have other features molded into them or pre-manufactured and attached. For example, tie down loops (not shown) could be molded into the side rails 12 which allow for the objects being stored on the roof rack 10 to be tied down to a strong anchor. Another example would be lights 92 on the side rails 12. The lights 92 (not shown) could be placed anywhere on the side rail 12 with the electrical wiring be covered by the components of the roof rack 10. Thus, the lights 92 could be used for decorations or have a functional purpose such as additional turn signals.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A roof rack comprising:
a plurality of side rails, wherein said plurality of side rails has a base and a top; and,
at least one cross rail, wherein said cross rail has a first position and a second position, and said cross rail is at a lower height when in said first position than when said cross rail is in said second position.

2. The roof rack of claim 1 further comprising a stanchion, wherein said side rail is attached to a first end of said stanchion and said cross rail is attached to a second end of said stanchion.

3. The roof rack of claim 2, wherein said stanchion has a connector that connects said first end to said side rail and said stanchion pivots about said connector in order to move said cross rail between said first position and said second position.

4. The roof rack of claim 1, wherein a pin extends into said side rail when said cross rail is in said second position.

5. The roof rack of claim 1, wherein a lever is used to move said cross rail from said second position to said first position.

6. The roof rack of claim 1 further comprising at least one stopper that is attached to each said side rail.

7. The roof rack of claim 3, wherein said stopper is a lower height than said side rail.

8. The roof rack of claim 1 further comprising a first panel that extends between and attaches to said side rails at a front end of said side rails.

9. The roof rack of claim 8, wherein said first panel has a first angled surface such that a base of said first angled surface is at a similar height as said base of said side rail and a top of said first angled surface is at a similar height as said top of said side rail.

10. The roof rack of claim 1 further comprising a second panel that extends between and attaches to said side rails at a rear end of said side rails.

11. The roof rack of claim 10, wherein said second panel has a second angled surface such that a base of said second angled surface is at a similar height as said base of said side rail and a top of said second angled surface is at a similar height as said top of said side rail.

12. A roof rack comprising:
a plurality of side rails, wherein said plurality of side rails has a base and a top;
a stanchion, wherein said side rail is attached to a first end of said stanchion; and,
at least one cross rail, wherein said cross rail is attached to a second end of said stanchion, and said cross rail has a first position and a second position such that when said cross rail is at a lower height when in said first position than when said cross rail is in said second position.

13. The roof rack of claim 12, wherein said stanchion has a connector that connects said first end to said side rail and said stanchion pivots about said connector in order to move said cross rail between said first position and said second position.

14. The roof rack of claim 12, wherein a pin extends into a base of said stanchion and into said side rail when said cross rail is in said second position.

15. The roof rack of claim 12, wherein said stanchion has a lever which is used to move said cross rail from said second position to said first position.

16. The roof rack of claim 12 further comprising at least one stopper that is attached to each said side rail, wherein said stopper is at a lower height than said side rail.

17. The roof rack of claim 12 further comprising a first panel that extends between and attaches to said side rails at a front end of said side rails, wherein said first panel has a first angled surface such that a base of said first angled surface is at a similar height as said base of said side rail and a top of said first angled surface is at a similar height as said top of said side rail.

18. The roof rack of claim 12 further comprising a second panel that extends between and attaches to said side rails at a rear end of said side rails, wherein said second panel has a second angled surface such that a base of said second angled surface is at a similar height as said base of said side rail and a top of said second angled surface is at a similar height as said top of said side rail.

19. A roof rack comprising:
a plurality of side rails, wherein said plurality of side rails has a base and a top;
a stanchion, wherein said side rail is attached to a first end of said stanchion;
a connector that connects said first end of said stanchion to said side rail, and said stanchion pivots about said connector in order to move said cross rail between said first position and said second position;
at least on stopper, wherein said at least one stopper is attached to each said side rail, and said stopper is at a lower height than said side rail;
a first panel that extends between and attaches to said side rails at a front end of said side rails;
a second panel that extends between and attaches to said side rails at a rear end of said side rails; and,
at least one cross rail, wherein said cross rail is attached to a second end of said stanchion, and said cross rail has a first position and a second position such that when said cross rail is at a lower height when in said first position than when said cross rail is in said second position.

20. The roof rack of claim 19, wherein said stanchion has a lever and pin mechanism where said pin extends through said stanchion and into said side rail when said cross rail is in said second position, and said lever removes said pin from said side rail when said cross rail is moving between said second position and said first position.
